(19) United States
(12) Patent Application Publication
(10) Pub. No.: US 2009/0034076 A1
(43) Pub. Date: Feb. 5, 2009

(54) LENS APPARATUS, SUPPORT APPARATUS THEREFOR, AND IMAGE CAPTURING SYSTEM

(75) Inventors: Masaki Suzui, Utsunomiya-shi (JP); Masaomi Kanayama, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/178,330

(22) Filed: Jul. 23, 2008

(30) Foreign Application Priority Data
Jul. 31, 2007 (JP) 2007-199094

(51) Int. Cl. G02B 27/64

(52) U.S. Cl. 359/557

(57) ABSTRACT

A lens apparatus is electrically connected to a support apparatus including a detecting unit that detects displacement information corresponding to pan or tilt. The lens apparatus includes a converter configured to convert the displacement information into control information; an image stabilization unit configured to perform image stabilization by using the control information; and a format transmitting unit configured to transmit a signal used for discriminating a format of the displacement information to the converter. The converter uses the signal transmitted from the format transmitting unit to convert the displacement information into the control information.

### BACKGROUND OF THE INVENTION

1. Field of the Invention

The present invention relates to a lens apparatus and a support apparatus for supporting the lens apparatus, which are included in an image capturing system having an image stabilization function.

2. Description of the Related Art

Image capturing systems having an image stabilization function are known. The image stabilization function is for correcting image blur occurring when the image capturing systems are vibrated. Such an image capturing system includes a lens apparatus having an image stabilization unit, a support apparatus that includes a tripod and a camera platform and that supports the lens apparatus, and a camera apparatus (for example, refer to Japanese Patent Laid-Open No. 2006-317585).

The lens apparatus converts displacement information (for example, position data) in the panning and tilting directions, which is output from an operation angle detecting unit included in the support apparatus, into control information for image stabilization and uses the control information to control the image stabilization unit.

The control information is used for the image stabilization and includes pan and tilt operation positions (absolute values) and amounts of displacement (relative values) of the operation position.

The image capturing system disclosed in Japanese Patent Laid-Open No. 2006-317585 does not use an angular rate sensor, which is used in general image capturing systems having the image stabilization function. Accordingly, the image capturing system does not affected by low-frequency noise involved in the vibration and has the axis of vibration agreeing with the axis of vibration detection, so that the vibration information can be always accurately detected. Consequently, the image capturing system performs the image stabilization without reducing the image stabilization effect on the low-frequency vibration.

In general, the displacement information is output from the support apparatus in various formats, such as angle values, pulse waves, counts of the pulse waves, analog voltage, and resolution. In addition, time elements, such as a time interval (cycle) of the displacement information output from the support apparatus, are output in various formats.

However, the image capturing systems in related art described above do not suppose the support for the various formats of the displacement information by the image stabilization operation of the lens apparatuses and cannot convert the displacement information of various formats into the control information appropriate for certain image stabilization units.

Accordingly, with a combination of a lens apparatus and a support apparatus outputting displacement information of a format different from that of the displacement information processed in the lens apparatus, the lens apparatus cannot convert the displacement information into the control information when the displacement information is output from the support apparatus in a format that is not included in predetermined formats. In other words, the lens apparatus cannot realize the image stabilization by using the displacement information (control information) output from the support apparatus.

### SUMMARY OF THE INVENTION

It is desirable for a lens apparatus to convert displacement information transmitted from a support apparatus into control information for image stabilization regardless of the format of the displacement information.

According to an embodiment of the present invention, a lens apparatus is configured to be electrically connected to a support apparatus including a detecting unit that detects displacement information corresponding to pan or tilt. The lens apparatus includes a converter configured to convert the displacement information into control information; an image stabilization unit configured to perform image stabilization by using the control information; and a format transmitting unit configured to transmit a signal used for discriminating a format of the displacement information to the converter. The converter uses the signal transmitted from the format transmitting unit to convert the displacement information into the control information.

According to another embodiment of the present invention, a support apparatus is configured to be electrically connected to a lens apparatus including an image stabilization unit that performs image stabilization by using control information. The support apparatus includes a detecting unit configured to detect displacement information corresponding to pan or tilt; a converter configured to convert a format of the displacement information into a format of displacement information to be transmitted to the lens apparatus; and a format transmitting unit configured to transmit a signal used for discriminating the format of the displacement information that can be converted into the control information in the lens apparatus to the converter. The converter uses the signal transmitted from the format transmitting unit to convert the format of the displacement information.

According to another embodiment of the present invention, an image capturing system includes a support apparatus including a detecting unit that detects displacement information corresponding to pan or tilt; a lens apparatus including an image stabilization unit that performs image stabilization by using control information converted from the displacement information; and a format conversion apparatus electrically connected to the support apparatus and the lens apparatus. The format conversion apparatus includes a converter that converts a format of the displacement information output from the support apparatus into a format of displacement information that can be converted into the control information in the lens apparatus.

Further features of the present invention will become apparent from the following description of exemplary embodiments with reference to the attached drawings.

### BRIEF DESCRIPTION OF THE DRAWINGS

FIG. 1 is a functional block diagram showing an example of the configuration of an image capturing system according to a first exemplary embodiment of the present invention.

FIG. 2 is a table showing conversion tables held in a memory according to the first exemplary embodiment of the present invention.

FIG. 3 is a flowchart showing an example of signal processing according to the first exemplary embodiment of the present invention.

FIG. 4 is a functional block diagram showing an example of the configuration of an image capturing system according to a second exemplary embodiment of the present invention.

FIG. 5 is a functional block diagram showing an example of the configuration of an import switch according to the second exemplary embodiment of the present invention.

FIG. 6 is a table showing conversion tables according to the second exemplary embodiment of the present invention.

FIG. 7 is a flowchart showing an example of signal processing according to the second exemplary embodiment of the present invention.

FIG. 8 is a functional block diagram showing an example of the configuration of an image capturing system according to a third exemplary embodiment of the present invention.

FIG. 9 is a table showing conversion tables according to the third exemplary embodiment of the present invention.

FIG. 10 is a flowchart showing an example of a communication process according to the third exemplary embodiment of the present invention.

FIG. 11 is a sequence chart showing an example of a communication sequence according to the third exemplary embodiment of the present invention.

FIG. 12 is a flowchart showing an example of signal processing according to the third exemplary embodiment of the present invention.

FIG. 13 is a functional block diagram showing an example of the configuration of an image capturing system according to a fourth exemplary embodiment of the present invention.

FIG. 14 is a table showing conversion tables according to the fourth exemplary embodiment of the present invention.

FIG. 15 is a flowchart showing an example of a communication process according to the fourth exemplary embodiment of the present invention.

FIG. 16 is a sequence chart showing an example of a communication sequence according to the fourth exemplary embodiment of the present invention.

FIG. 17 is a functional block diagram showing an example of the configuration of an image capturing system according to a fifth exemplary embodiment of the present invention.

FIG. 18 is a table showing communication information according to the fifth exemplary embodiment of the present invention.

FIG. 19 is a flowchart showing an example of a communication process according to the fifth exemplary embodiment of the present invention.

FIG. 20 is a sequence chart showing an example of a communication sequence according to the fifth exemplary embodiment of the present invention.

### DESCRIPTION OF THE EMBODIMENTS

Embodiments of the present invention will herein be described with reference to the attached drawings.

Since the same reference numerals are used in the drawings to refer to the same components, a description of such components is not repeated. Similarly, the conversion tables of the same number have the same configuration. Operations of a support apparatus include the operation of a pan unit (horizontal drive) and the operation of a tilt unit (vertical drive). The operation of the pan unit is mainly described because the same processing is performed in a lens apparatus and the support apparatus in an image capturing system both for the pan unit and the tilt unit.

It is further noted that the tilt unit basically operates in a similar manner as in the pan unit.

### First Exemplary Embodiment

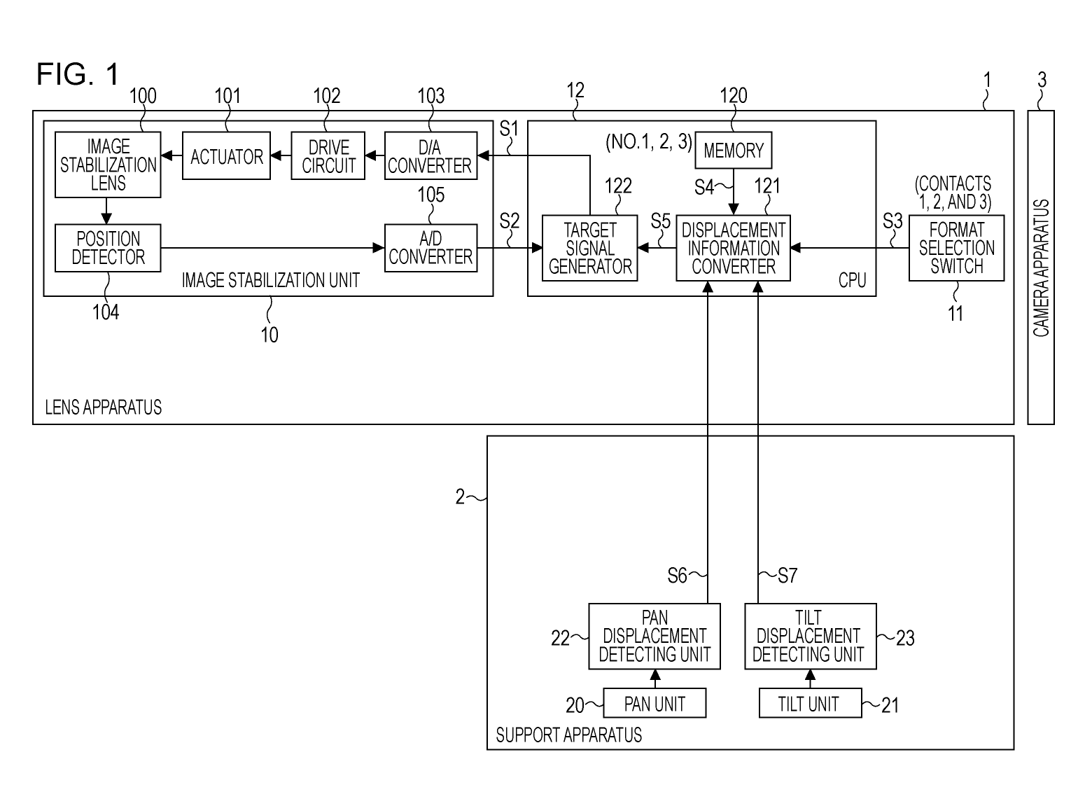

A first exemplary embodiment of the present invention will now be described with reference to FIGS. 1 to 3.

According to the first exemplary embodiment, a lens apparatus includes a format transmitting unit that transmits a signal used for discriminating the format of displacement information S6 (S7) output from a support apparatus to a converter that performs conversion into control information S5 used for image stabilization.

FIG. 1 is a functional block diagram showing an example of the configuration of an image capturing system according to the first exemplary embodiment of the present invention.

The image capturing system according to the first exemplary embodiment includes a lens apparatus 1, a support apparatus 2 including a tripod and a camera platform, and a camera apparatus 3 acquiring information about a subject. The lens apparatus 1, the support apparatus 2, and the camera apparatus 3 are electrically connected to each other.

The lens apparatus 1 mainly includes an image stabilization unit 10, a format selection switch 11, and a central processing unit (CPU) 12.

The image stabilization unit 10 includes an image stabilization lens 100 capable of mechanically shifting so as to provide components orthogonal to the optical axis, an actuator 101 driving the image stabilization lens 100, and a drive circuit 102 driving the actuator 101. In addition, the image stabilization unit 10 includes a digital-to-analog (D/A) converter 103 converting a target signal S1 (digital signal) supplied from the CPU 12 into a drive signal (analog signal). Furthermore, the image stabilization unit 10 includes a position detector 104 detecting the amount of shift of the image stabilization lens 100 and an analog-to-digital (A/D) converter 105 converting a detection result (analog signal) in the position detector 104 into a follow signal S2 (digital signal). The image stabilization unit 10 having the above configuration uses the target signal S1 supplied from the CPU 12 to mechanically shift the image stabilization lens 100 through the drive circuit 102 and the actuator 101. The result of shift of the image stabilization lens 100 is detected by the position detector 104, is converted into the digital signal by the A/D converter 105, and is supplied to the CPU 12 as the follow signal S2.

The format selection switch 11 functions as the format transmitting unit outputting a signal used for discriminating the format of the displacement information output from the support apparatus 2. The format selection switch 11 is a manual mechanical switch including three contacts 1, 2 and 3 and supplies a selection signal S3 indicating the selection result corresponding to the format of the displacement information to the CPU 12.

The CPU 12 mainly includes a memory 120, a displacement information converter 121, and a target signal generator 122 generating the target signal S1. The memory 120 includes conversion tables used by the displacement information converter 121 to convert the displacement information S6 (S7) output from the support apparatus 2 into the control information S5 used for the image stabilization and outputs a table signal (conversion table) S4.

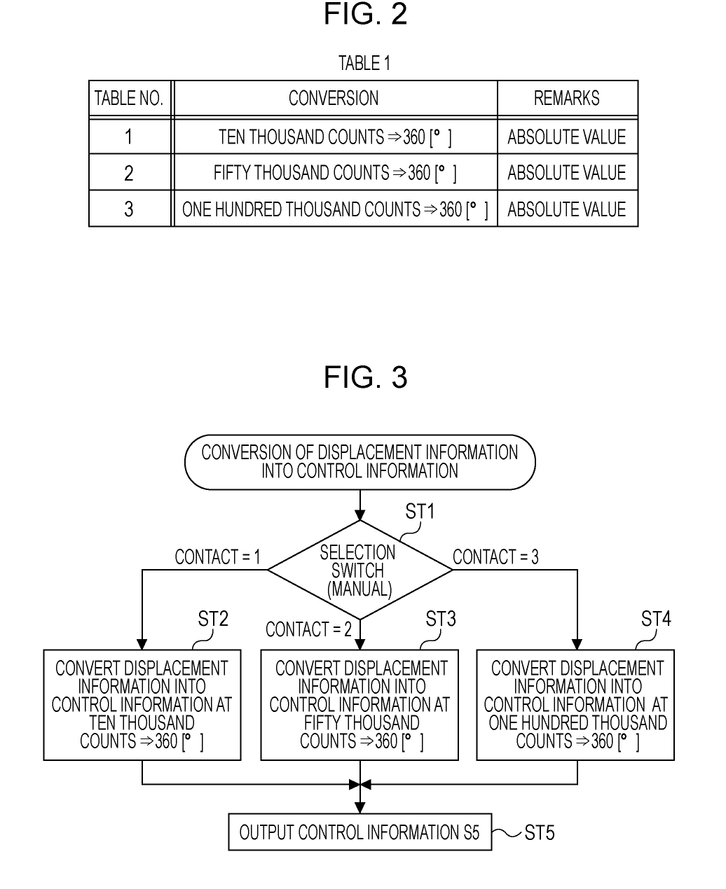

FIG. 2 is Table 1 showing three conversion tables No. 1 to No. 3 held in the memory 120. The conversion table No. 1 performs conversion in which zero count of the displacement information S6 (S7) is converted into zero [°] and ten thousand counts of the displacement information S6 (S7) are converted into 360 [°] The conversion table No. 2 performs conversion in which zero count of the displacement information S6 (S7) is converted into zero [°] and fifty thousand counts of the displacement information S6 (S7) are converted into 360 [°]. The conversion table No. 3 performs conversion in which zero count of the displacement information S6 (S7) is converted into zero [°] and ten hundred thousand counts of the displacement information S6 (S7) are converted into 360 [°]. Linear interpolation is performed for intermediate values to calculate angles. Zero [°] is equivalent to 360 [°].

The displacement information converter 121 is a computing unit converting the displacement information S6 (S7) into the control information S5 used for the image stabilization. The displacement information converter 121 receives the displacement information S6 (S7), the table signal S4, and the selection signal S3 output from the support apparatus 2, the memory 120, and the format selection switch 11, respectively. The displacement information converter 121 acquires the conversion table S4 from the memory 120 in accordance with the selection signal S3 and converts the displacement information S6 (S7) into the control information S5 (for example, an angle value θ) on the basis of the content of the conversion in the conversion table S4.

The target signal generator 122 generates a control target value of the image stabilization unit 10 by using the input control information S5 and outputs the target signal S1, which is the difference between the generated control target value and the follow signal S2 supplied from the image stabilization unit 10. For example, the target signal generator 122 calculates the amount of pan or tilt displacement Δθ (the amount of shift Δθ of the operation angle) from the control information S5 and generates a control target value in the direction offsetting the amount of displacement Δθ. The target signal generator 122 outputs the difference between the control target value and the follow signal S2 as the target signal S1. When the amount of displacement Δθ exceeds a predetermined threshold value, the target signal generator 122 determines that the panning or tilting is performed and stops the image stabilization or lessens the effect of the image stabilization.

FIG. 3 is a flowchart showing an example of a process of converting the displacement information into the control information in the lens apparatus 1.

Referring to FIG. 3, in Step ST1, the format selection switch 11 supplies the selection signal S3 to the displacement information converter 121 on the basis of the result of the manual selection (one of the contacts 1 to 3). In Steps ST2 to ST4, the displacement information converter 121 acquires the conversion table S4 from the memory 120 in accordance with the selection signal S3 and converts the displacement information S6 (S7) supplied from a displacement detecting unit described below into the control information S5.

When the format selection switch 11 selects the contact 1, the process goes to Step ST2. When the format selection switch 11 selects the contact 2, the process goes to Step ST3. When the format selection switch 11 selects the contact 3, the process goes to Step ST4.

In Step ST2, the displacement information converter 121 acquires the conversion table No. 1 from the memory 120 in accordance with the selection signal S3 and converts the displacement information S6 (S7) into the control information S5 at a conversion rate at which ten thousand counts of the displacement information S6 (S7) are converted into 360 [°]. In Step ST3, the displacement information converter 121 acquires the conversion table No. 2 from the memory 120 in accordance with the selection signal S3 and converts the displacement information S6 (S7) into the control information S5 at a conversion rate at which fifty thousand counts of the displacement information S6 (S7) are converted into 360 [°]. In Step ST4, the displacement information converter 121 acquires the conversion table No. 3 from the memory 120 in accordance with the selection signal S3 and converts the displacement information S6 (S7) into the control information S5 at a conversion rate at which one hundred thousand counts of the displacement information S6 (S7) are converted into 360 [°].

In Step ST5, the displacement information converter 121 outputs the control information S5. It is assumed in the following embodiments that the contacts and conversion table having the same numbers operate in synchronization with each other.

For example, when the contact 1 of the format selection switch 11 is selected, the displacement information converter 121 acquires the conversion table No. 1 from the memory 120. Similarly, the displacement information converter 121 acquires the conversion table No. 2 from the memory 120 when the contact 2 of the format selection switch 11 is selected and acquires the conversion table No. 3 from the memory 120 when the contact 3 of the format selection switch 11 is selected.

The support apparatus 2 according to the first exemplary embodiment mainly includes a pan unit 20 and a tilt unit 21, which are movable parts in the panning and tilting directions, respectively, and a pan displacement detecting unit 22 and a tilt displacement detecting unit 23, which detect the displacement in the panning and tilting directions, respectively.

The pan displacement detecting unit 22 and the tilt displacement detecting unit 23 each include a known incremental rotary encoder and a counter. For example, the pan displacement detecting unit 22 or the tilt displacement detecting unit 23 outputs zero count when the operation angle in the panning or tilting direction is zero [°] and outputs ten thousand counts when the operation angle in the panning or tilting direction is 360 [°]. Zero [°] is equivalent to 360 [°]. The linear interpolation is performed for intermediate operation angles to output the count values.

The lens apparatus 1 having the above configuration according to the first exemplary embodiment switches the conversion table S4 between the conversion tables No. 1 to No. 3 in accordance with the result of the selection from the contacts 1, 2, and 3 in the format selection switch 11. Accordingly, the displacement information S6 (S7) of different formats can be converted into the control information S5, which can be used for the image stabilization.

In other words, the format selection switch 11 can be switched so as to select the contact 2 or 3 to support the displacement information of the format in which fifty thousand counts of the displacement information S6 (S7) are converted into 360 [°] or of the format in which one hundred thousand counts of the displacement information S6 (S7) are converted into 360 [°], which is different from the format in which an operation angle zero [°] is converted into zero count of the displacement information S6 (S7) and an operation angle 360 [°] is converted into ten thousand counts of the displacement information S6 (S7).

For example, in the support apparatus 2 described above, the relationship between the operation angle of the displacement information S6 (S7) and the count value (numerical value) agrees with the content of the conversion table No. 1. Accordingly, manually setting the format selection switch 11 so as to select the contact 1 (corresponding to the conversion table No. 1) allows the displacement information S6 (S7) to be used as the control information S5 for the image stabilization.

Similarly, when fifty thousand counts of the displacement information S6 (S7) output from the support apparatus 2 are converted into 360 [°], the format selection switch 11 is set so as to select the contact 2 (corresponding to the conversion table No. 2). When one hundred thousand counts of the displacement information S6 (S7) output from the support apparatus 2 are converted into 360 [°], the format selection switch 11 is set so as to select the contact 3 (corresponding to the conversion table No. 3).

In other words, one of the conversion tables No. 1 to No. 3 (the settings of the switch) in the memory 120 is selected with the format selection switch 11 in accordance with the format of the displacement information output from the support apparatus.

Although the support apparatus 2 outputs the displacement information of the three different formats in the first exemplary embodiment, the number of choices of the format selection switch 11 and the number of the conversion tables held in the memory 120 may be increased. This allows more formats to be supported.

Although the support apparatus 2 according to the first example embodiment includes the pan unit and the tilt unit and detects the displacement in the panning and tilting directions, the support apparatus 2 may include one of the pan unit and the tilt unit or may detect the displacement in one of the panning and tilting directions.

### Second Exemplary Embodiment

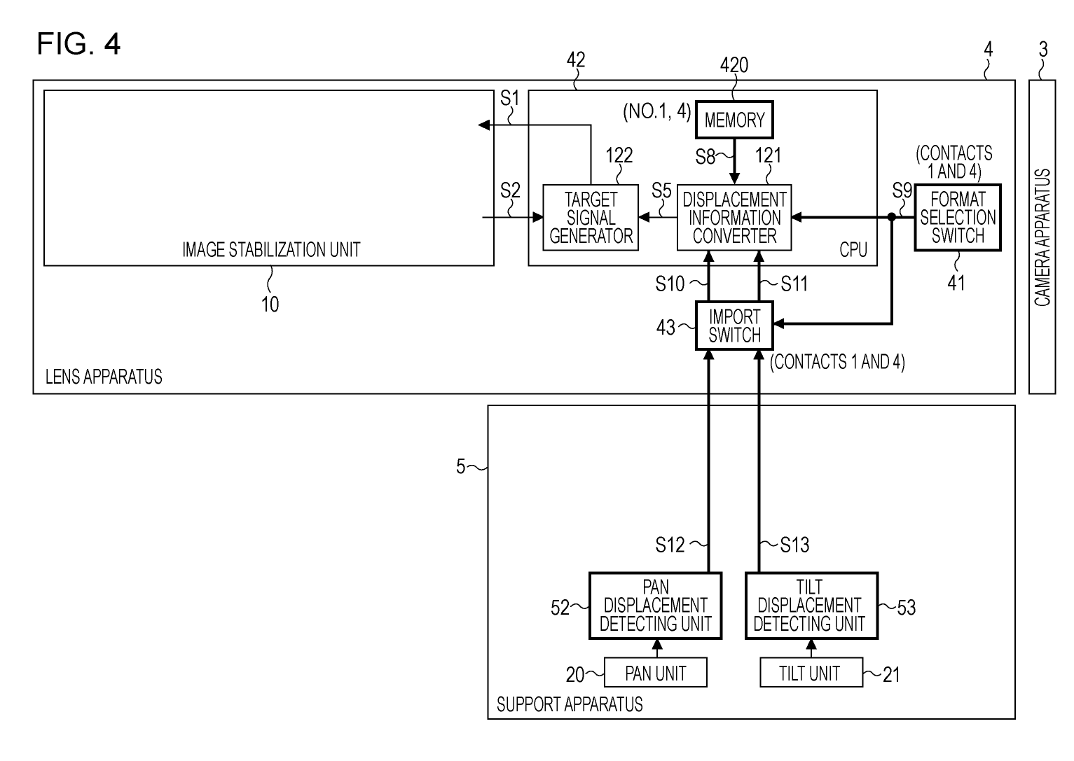

A second exemplary embodiment of the present invention will now be described with reference to FIGS. 4 to 7.

A lens apparatus in the second exemplary embodiment differs from the lens apparatus 1 in the first exemplary embodiment in that an import switch performs switching of hardware, in addition to the switching of the conversion tables in the CPU.

FIG. 4 is a functional block diagram showing an example of the configuration of an image capturing system according to the second exemplary embodiment of the present invention.

A lens apparatus 4 according to the second exemplary embodiment mainly includes the image stabilization unit 10, a format selection switch 41, a CPU 42, and an import switch 43.

The format selection switch 41 differs from the format selection switch 11 shown in FIG. 1 in that the format selection switch 41 have contacts 1 and 4. The format selection switch 41 outputs a selection signal S9 used for discriminating the format of the displacement information output from a support apparatus 5 in accordance with the selected contact. Also in the second exemplary embodiment, the format selection switch 41 functions as the format transmitting unit outputting a signal used for discriminating the format of the displacement information output from the support apparatus 5.

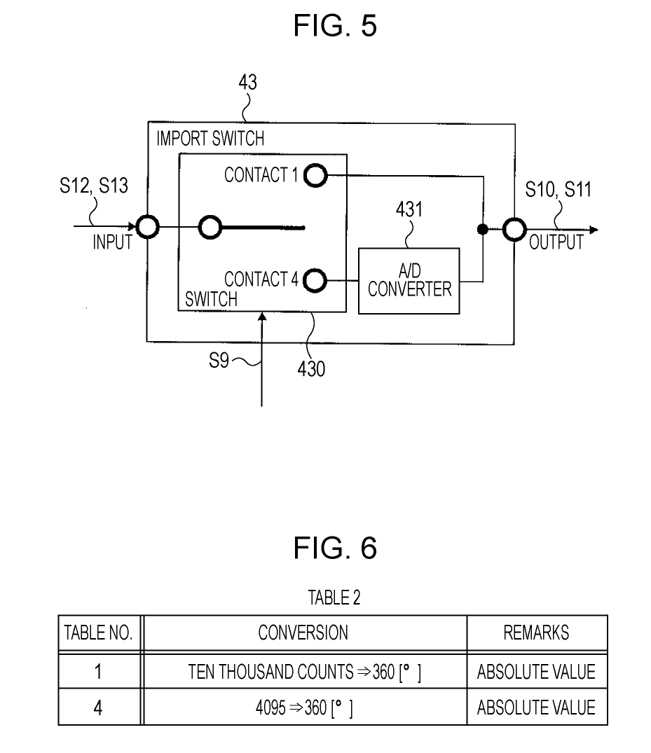

FIG. 5 is a functional block diagram showing an example of the configuration of the import switch 43. The import switch 43 mainly includes a switch 430 and an A/D converter 431.

The switch 430 is an electronic switch having two contacts 1 and 4. The contact 1 is connected to the output port of the import switch 43 and the contact 4 is connected to the import switch 43. The switch 430 is an electronic switch operating in accordance with the selection signal S9. When the contact 1 or 4 is selected with the format selection switch 41, the import switch 43 selects the contact 1 or 4 in accordance with the selection result in the format selection switch 41.

The A/D converter 431 is a known 12-bit A/D converter. The A/D converter 431 outputs a digital value S10 (S11). The digital value S10 (S11) is equal to zero when the displacement information is input at zero V and is equal to 4,095 when the displacement information is input at ten V. The linear interpolation is performed for intermediate voltage values to output the digital values.

FIG. 6 is Table 2 showing two conversion tables No. 1 and No. 4 held in a memory 420 in the CPU 42. The memory 420 differs from the memory 120 shown in FIG. 1 only in the conversion tables that are held in the memory 420. The conversion table No. 1 is the same as the conversion table No. 1 in the first exemplary embodiment. The conversion table No. 4 performs conversion in which zero count of the displacement information S10 (S11) is converted into zero [°] and 4,095 counts of the displacement information S10 (S11) are converted into 360 [°]. The linear interpolation is performed for intermediate values to output the angles, as in the conversion table No. 1. The memory 120 outputs a table signal (conversion table) S8.

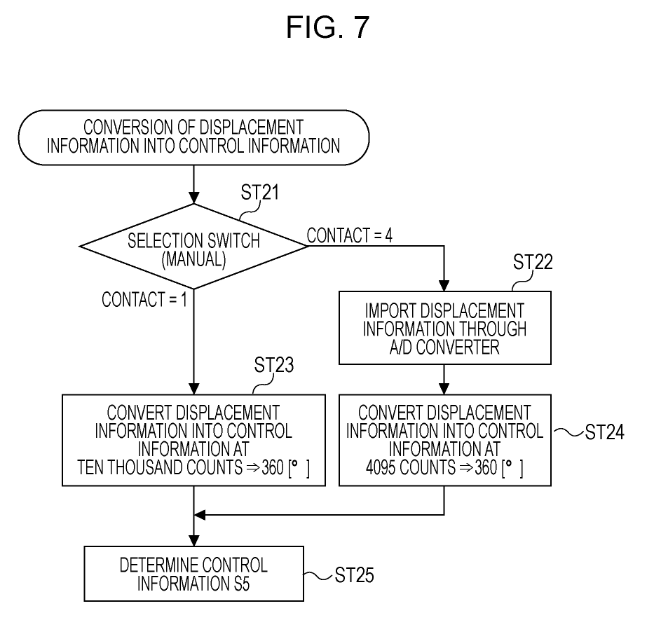

FIG. 7 is a flowchart showing an example of a process of converting the displacement information into the control information in the lens apparatus 4.

Referring to FIG. 7, in Step ST21, the format selection switch 41 outputs the selection signal S9 on the basis of the result of the manual selection. When the contact 1 is selected, the process goes to Step ST23. When the contact 4 is selected, the process goes to Step ST22. In Step ST22, the contact 4 is selected in the switch 430 and the displacement information is imported through the A/D converter 431.

In Step ST24, the displacement information converter 121 acquires the conversion table No. 4 (table signal S8) from the memory 420 in accordance with the selection signal S9. The displacement information converter 121 converts the displacement information S10 (S11) into the control information S5 at a conversion rate at which 4,095 counts of the displacement information are converted into 360 [°]. In Step ST23, the displacement information converter 121 acquires the conversion table No. 1 after the contact 1 is selected and the displacement information is imported without conversion and converts the displacement information S10 (S11) into the control information S5 at a conversion rate at which ten thousand counts of the displacement information are converted into 360 [°]. As described above, according to the second exemplary embodiment, the hardware switching is also performed in the import switch 43 in accordance with the format of the displacement information S10 (S11). In Step ST25, the displacement information converter 121 outputs the control information S5.

The support apparatus 5 mainly includes the pan unit 20, the tilt unit 21, a pan displacement detecting unit 52, and a tilt displacement detecting unit 53.

The pan displacement detecting unit 52 and the tilt displacement detecting unit 53 differ from the pan displacement detecting unit 22 and the tilt displacement detecting unit 23 shown in FIG. 1 in that the pan displacement detecting unit 52 and the tilt displacement detecting unit 53 each use a known potentiometer. The pan displacement detecting unit 52 and the tilt displacement detecting unit 53 output displacement information S12 (S13) indicating the panning and tilting operation positions (absolute values). In the displacement information S12 (S13), zero [°] corresponds to zero V and 360 [°] corresponds to 10 V.

The lens apparatus 4 having the above configuration according to the second exemplary embodiment imports the displacement information S12 (S13) in accordance with the result of the selection (the contact 1 or 4) in the format selection switch 41 and performs the hardware switching and conversion with the import switch 43. The lens apparatus 4 converts the displacement information S10 or S11 subjected to the conversion into the control information S5 to perform the image stabilization by using the control information S5. For example, since the support apparatus 5 outputs the analog voltage 10 V when the panning or tilting operation position is at 360 [°], the format selection switch 41 is switched to the contact 4. As a result, the import switch 43 is also switched to the contact 4 and the displacement information S12 (S13) is subjected to the A/D conversion by the A/D converter 431. The displacement information converter 121 converts the displacement information S12 (S13) in accordance with the conversion table No. 4 to calculate the control information S5.

If the support apparatus 5 is replaced with the support apparatus 2 in the first exemplary embodiment, the format selection switch 41 is switched to the contact 1 because the ten thousand counts of the displacement information are output at 360 [°]. As a result, the control information S5 is calculated as in the above example.

The lens apparatus 4 according to the second exemplary embodiment can switch the hardware importing the displacement information S12 (S13) when the hardware switching is required, as in the case where the displacement information is supplied as the analog signal and the digital signal (count value). Accordingly, the displacement information S12 (S13) supplied from the support apparatus 5 can be used for the image stabilization.

When the displacement information is a pulse wave from the encoder, a hardware device, such as a counter, may be added to provide a configuration in which the switching of the hardware and the software is performed as in the second exemplary embodiment.

The lens apparatus 4 according to the second exemplary embodiment can convert the displacement information of various formats output from the support apparatus 5 into the control information for the image stabilization regardless of the analog or digital format.

As described above, all the elements necessary for converting the displacement information into the control information are included as the target to be switched and the hardware switching necessary for the conversion is included. Switching between hardware and software may be performed, if necessary.

The various switches may be replaced with software switches when the hardware switching is not required.

### Third Exemplary Embodiment

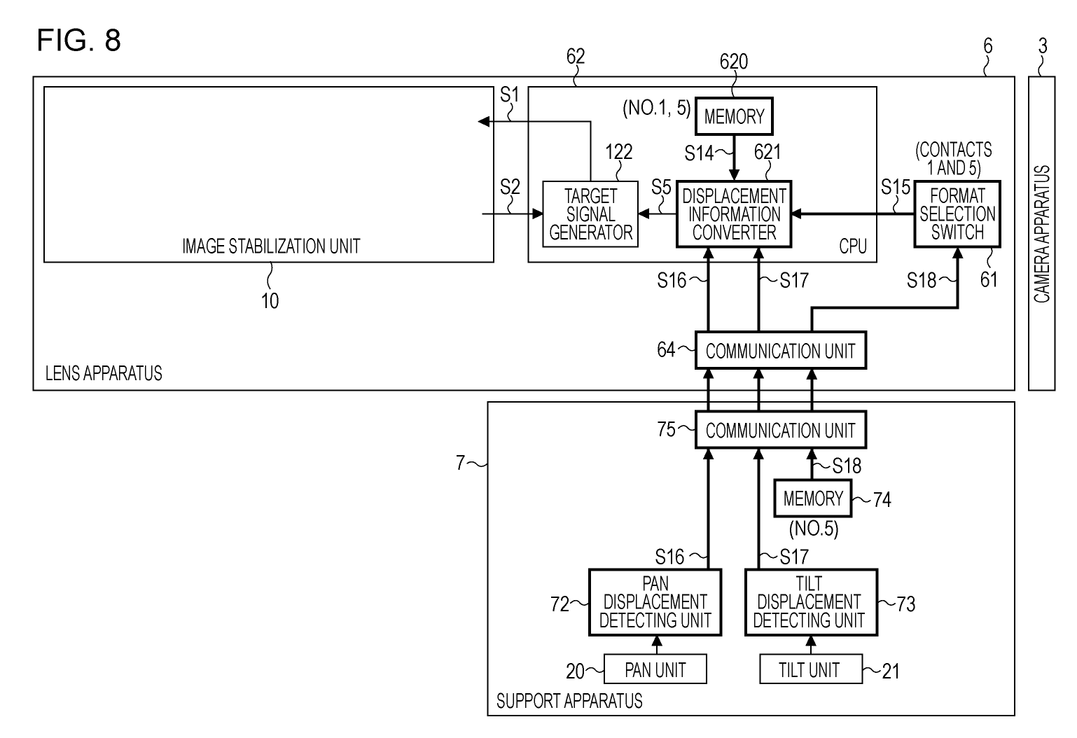

A third exemplary embodiment of the present invention will now be described with reference to FIGS. 8 to 12.

A lens apparatus 6 according to the third exemplary embodiment differs from the lens apparatus 1 according to the first exemplary embodiment in that the format of the displacement information output from a support apparatus 7 is acquired through communication units 64 and 75 provided between the lens apparatus 6 and the support apparatus 7 and that a format selection switch 61 is automatically switched in accordance with the acquired format of the displacement information. In addition, the support apparatus 7 having the displacement information of formats different from those in the support apparatus 2 shown in FIG. 1 is used instead of the support apparatus 2.

FIG. 8 is a functional block diagram showing an example of the configuration of an image capturing system according to the third exemplary embodiment of the present invention. The image capturing system according to the third exemplary embodiment includes the lens apparatus 6, the support apparatus 7, and the camera apparatus 3.

The lens apparatus 6 mainly includes the image stabilization unit 10, the format selection switch 61, a CPU 62, and the communication unit 64.

The format selection switch 61 receives a format information signal S18 from the support apparatus 7 through the communication unit 64. The format selection switch 61 outputs a selection signal S15. Also in the third exemplary embodiment, the format selection switch 61 functions as the format transmitting unit outputting a signal used for discriminating the format of the displacement information output from the support apparatus 7.

The CPU 62 mainly includes a memory 620, a displacement information converter 621, and the target signal generator 122.

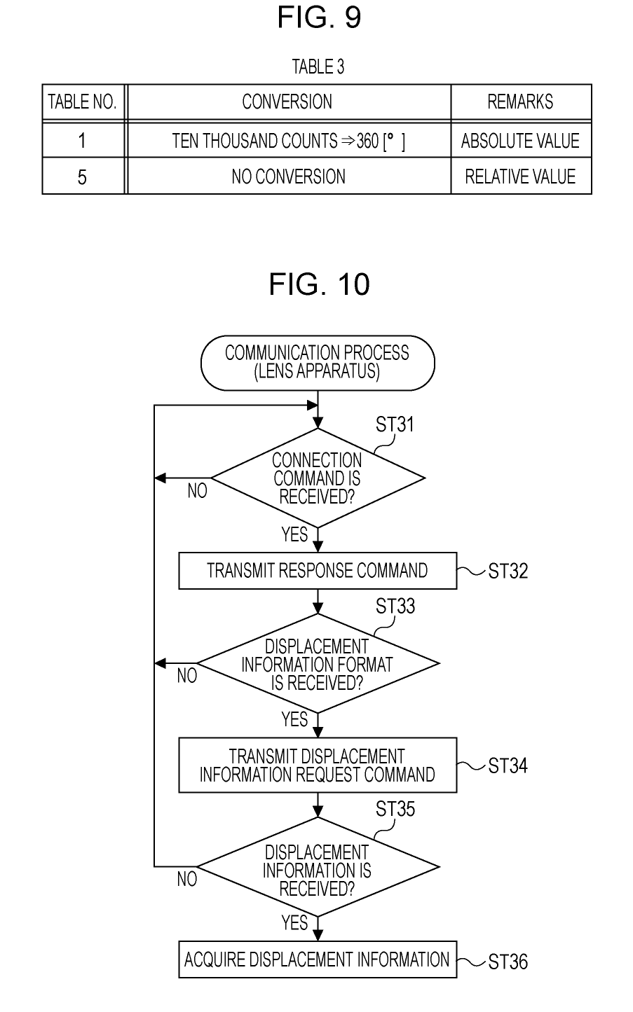

FIG. 9 is Table 3 showing two conversion tables No. 1 and No. 5 held in the memory 620. The conversion table No. 5 is a conversion table performing no conversion. The memory 620 outputs a table signal (conversion table) S14. The communication unit 64 performs communication with the communication unit 75 in the support apparatus 7. The communication unit 64 receives displacement information S16 (S17) and the format information signal S18 from the communication unit 75. The communication unit 64 supplies the displacement information S16 (S17) to the displacement information converter 621 and supplies the format information signal S18 to the format selection switch 61.

The support apparatus 7 mainly includes the pan unit 20, the tilt unit 21, a pan displacement detecting unit 72, a tilt displacement detecting unit 73, a memory 74, and the communication unit 75.

The pan displacement detecting unit 72 and the tilt displacement detecting unit 73 each include a known incremental rotary encoder, a counter, and an angle converter. The pan displacement detecting unit 72 and the tilt displacement detecting unit 73 output the displacement information S16 and S17 in the panning and tilting directions as digital values. The displacement information S16 and S17 indicate the amount of displacement (relative value) of the operation angle in a range from 0 [°] to 360 [°]. The angle converter is a calculator for calculating the amount of displacement of the operation angle (the relative value indicating the difference between the operation angle of the previous output and that of the current output) of the pan displacement detecting unit 72 or the tilt displacement detecting unit 73 from the information supplied from the counter.

The memory 74 holds the formats of the displacement information S16 and S17 output from the pan displacement detecting unit 72 and the tilt displacement detecting unit 73, respectively, and outputs the format information signal S18. The information held in the memory 74 indicates that the format of the displacement information is the amount of displacement (0 to 360 [°]) of the operation angle and the conversion table No. 5 is held in the memory 74.

The communication unit 75 transmits the displacement information S16 (S17) and the format information signal S18 to the communication unit 64 in the lens apparatus 6.

The communication will now be described in detail with reference to FIG. 10. FIG. 10 is a flowchart showing an example of a communication process between the lens apparatus 6 and the support apparatus 7.

Referring to FIG. 10, in Step ST31, the lens apparatus 6 waits for reception of a connection command from the support apparatus 7. If the lens apparatus 6 receives the connection command, then in Step ST32, the lens apparatus 6 transmits a response command. In Step ST33, the lens apparatus 6 waits for reception of a format of the displacement information. If a format of the displacement information is not received for a predetermined time period, the process goes back to Step ST31. If a format of the displacement information is received, then in Step ST34, the lens apparatus 6 transmits a displacement information request command. In Step ST35, the lens apparatus 6 waits for reception of displacement information. If the displacement information is not received for a predetermined time period, the process goes back to Step ST31. If the displacement information is received, then in Step ST36, the lens apparatus 6 receives the displacement information S16 or S17.

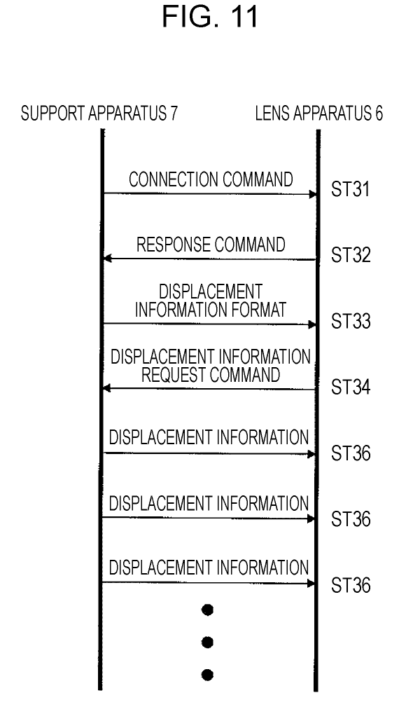

FIG. 11 is a sequence chart showing an example of the communication sequence between the lens apparatus 6 and the support apparatus 7.

The support apparatus 7 transmits the connection command to the lens apparatus 6 (Step ST31). When the support apparatus 7 receives the response command, which is a reply to the connection command, from the lens apparatus 6 (Step ST32), the support apparatus 7 transmits a format of the displacement information (Step ST33).

The formats of the displacement information according to the third exemplary embodiment include a count value/angle value and an absolute value/relative value (difference value). In the case of the count value, the format of the displacement information is the content of conversion into the angle value. In other words, the formats of the displacement information are information necessary for the lens apparatus to convert the displacement information of various formats output from the support apparatus into the pan or tilt operation position (absolute value) or the amount of operation (the amount of displacement), which is necessary for the image stabilization.

The lens apparatus 6 transmits the displacement information request command (Step ST34). The support apparatus 7 continues to transmit the displacement information on a predetermined cycle (Step ST36).

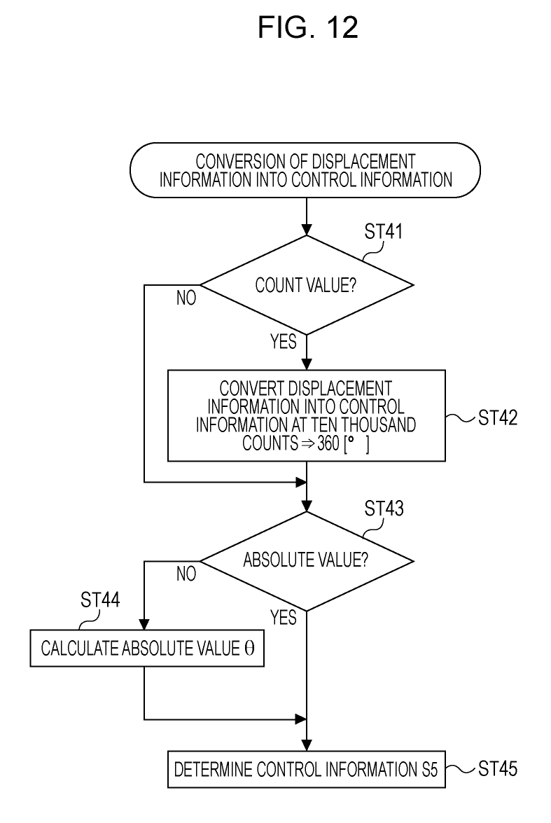

A process of converting the displacement information into the control information will now be described. FIG. 12 is a flowchart showing an example of the conversion process in the displacement information converter 621 in the lens apparatus 6.

Referring to FIG. 12, in Step ST41, the displacement information converter 621 determines whether the displacement information S16 (S17) is a count value on the basis of the information acquired from the format information signal S18. If the displacement information S16 (S17) is an angle value, the process goes to Step ST43. If the displacement information S16 (S17) is a count value, the process goes to Step ST42. In Step ST42, the displacement information converter 621 uses the conversion table (No. 1) in FIG. 9 to convert the count value to an angle value.

In Step ST43, the displacement information converter 621 determines whether the displacement information S16 (S17) is an absolute value on the basis of the information acquired from the format information signal S18. If the displacement information S16 (S17) is an absolute value (absolute position), the process goes to Step ST45. If the displacement information S16 (S17) is a relative value (difference value), the process goes to Step ST44. In Step ST44, the displacement information converter 621 acquires the total relative value from an original position (not shown) detected in advance to calculate an absolute value θ.

In Step ST45, the displacement information converter 621 determines the control information S5.

The lens apparatus 6 having the above configuration according to the third exemplary embodiment uses the communication unit 64, instead of the format selection switch 11 according to the first exemplary embodiment or the format selection switch 41 according to the second exemplary embodiment, to acquire the format of the displacement information (the conversion table No. 5) from the support apparatus 7. The lens apparatus 6 automatically switch the conversion table used in the displacement information converter 621 on the basis of the acquired format of the displacement information.

Although the communication process and the communication sequence are described with reference to FIGS. 10 and 11 in the third exemplary embodiment, the order of the communication and the content thereof may be varied as long as the information necessary for the process of converting the displacement information S16 (S17) into the control information S5 is acquired.

For example, the lens apparatus 6 may acquire the displacement information from the support apparatus 7 and, then, may acquire the information (the count value/angle value and the absolute value/relative value in the third exemplary embodiment) necessary for the conversion process to use the displacement information for the image stabilization.

In addition, the acquired format of the displacement information may be used for the image stabilization at an arbitrary timing.

The format of the displacement information S16 (S17) output from the support apparatus 7 may not be completely agree with the format of the displacement information processed in the lens apparatus 6. For example, the displacement information S16 (S17) output from the support apparatus 7 may be different from the format of the displacement information processed in the lens apparatus 6 in resolution.

It is sufficient for the format of the displacement information of the support apparatus 7 to be converted into the pan or tilt operation position (absolute value) or the amount of displacement (relative value) of the pan or tilt operation in the displacement information converter 621 in the lens apparatus 6. The same applies to the other embodiments including the case where the format is not automatically acquired.

Making the conversion tables in the memory 620 in the lens apparatus 6 updatable eliminates the restriction about the conversion table in the lens apparatus 6 to support more types of support apparatuses. The memory in the lens apparatus 6 may be updated with a displacement format signal supplied through the communication unit. The conversion table may be acquired or updated via an external recording medium or over a network.

In any of the above cases, the lens apparatus can automatically acquire the conversion table to switch the content of the conversion regardless of the formats (such as the count value, the angle value, the absolute value, the difference value, and information about conversion into the angle value) of the displacement information output from the support apparatus.

The update of the conversion table may be performed along with the hardware switching.

### Fourth Exemplary Embodiment

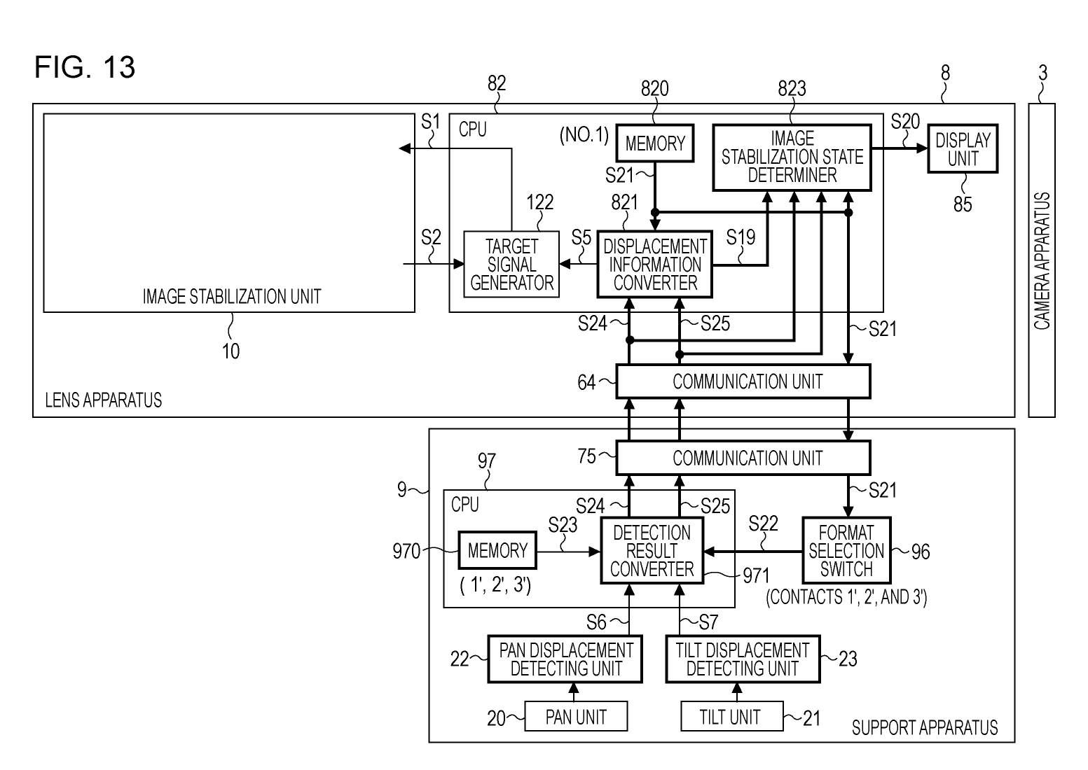

A fourth exemplary embodiment of the present invention will now be described with reference to FIGS. 13 to 16.

An image capturing system according to the fourth exemplary embodiment differs from the image capturing system according to the third exemplary embodiment in that the support apparatus acquires information used in the conversion of the displacement information into the control information from the lens apparatus by communication and switches the format of the displacement information to be output in accordance with the acquired information. The mage capturing system according to the fourth exemplary embodiment differs from the image capturing system according to the third exemplary embodiment also in that the lens apparatus is provided with a display unit in which information that is acquired by using the displacement information and that concerns the image stabilization is displayed.

FIG. 13 is a functional block diagram showing an example of the configuration of the image capturing system according to the fourth exemplary embodiment of the present invention. The image capturing system according to the fourth exemplary embodiment includes a lens apparatus 8, a support apparatus 9, and the camera apparatus 3.

The lens apparatus 8 mainly includes the image stabilization unit 10, a CPU 82, the communication unit 64, a display unit 85.

The CPU 82 mainly includes a memory 820, a displacement information converter 821, the target signal generator 122, and an image stabilization state determiner 823.

The memory 820 only includes the conversion table No. 1.

The displacement information converter 821 acquires a conversion table S21 (the conversion table No. 1) and converts displacement information S24 (S25) into the control information S5 in accordance with the acquired conversion table No. 1. The displacement information converter 821 outputs an image stabilization state signal S19 indicating whether the displacement information S24 (S25) is converted into the control information S5 to the image stabilization state determiner 823.

The image stabilization state determiner 823 receives the image stabilization state signal S19 to determine whether the image stabilization is performed. In addition, the image stabilization state determiner 823 receives the conversion table S21 and the displacement information S24 (S25) to determine whether the displacement information S24 (S25) is available for the image stabilization. The image stabilization state determiner 823 outputs the two determination results as a determination result signal S20. The determination of whether the displacement information S24 (S25) is available for the image stabilization is based on, for example, whether the displacement information received by the lens apparatus 8 agrees with the conversion table held in the memory 820.

The display unit 85 is a known liquid crystal display. The display unit 85 receives the determination result signal S20 and displays the determination result on the screen.

The communication unit 64 communicates with the support apparatus 9 to receive the displacement information S24 (S25). The communication unit 64 transmits the conversion table S21 to the support apparatus 9.

The support apparatus 9 mainly includes the pan unit 20, the tilt unit 21, the pan displacement detecting unit 22, the tilt displacement detecting unit 23, the communication unit 75, a format selection switch 96, and a CPU 97.

The communication unit 75 communicates with the lens apparatus 8 to transmit the displacement information S24 (S25). The communication unit 75 receives the conversion table S21 from the lens apparatus 8.

The format selection switch 96 receives the conversion table S21 and outputs a switch signal S22 in accordance with the received conversion table S21. According to the fourth exemplary embodiment, the format selection switch 96 functions as the format transmitting unit that discriminates the format of the displacement information convertible into the control information in the lens apparatus 8 on the basis of the received conversion table S21 and that supplies the switch signal S22 in accordance with the discriminated format to a detection result converter 971 described below.

The CPU 97 mainly includes a memory 970 and the detection result converter 971. The memory 970 includes conversion tables used for converting the displacement information S6 output from the pan displacement detecting unit 22 (the displacement information S7 output from the tilt displacement detecting unit 23) into the displacement information S24 (S25) to be supplied to the lens apparatus 8 through the communication unit 75.

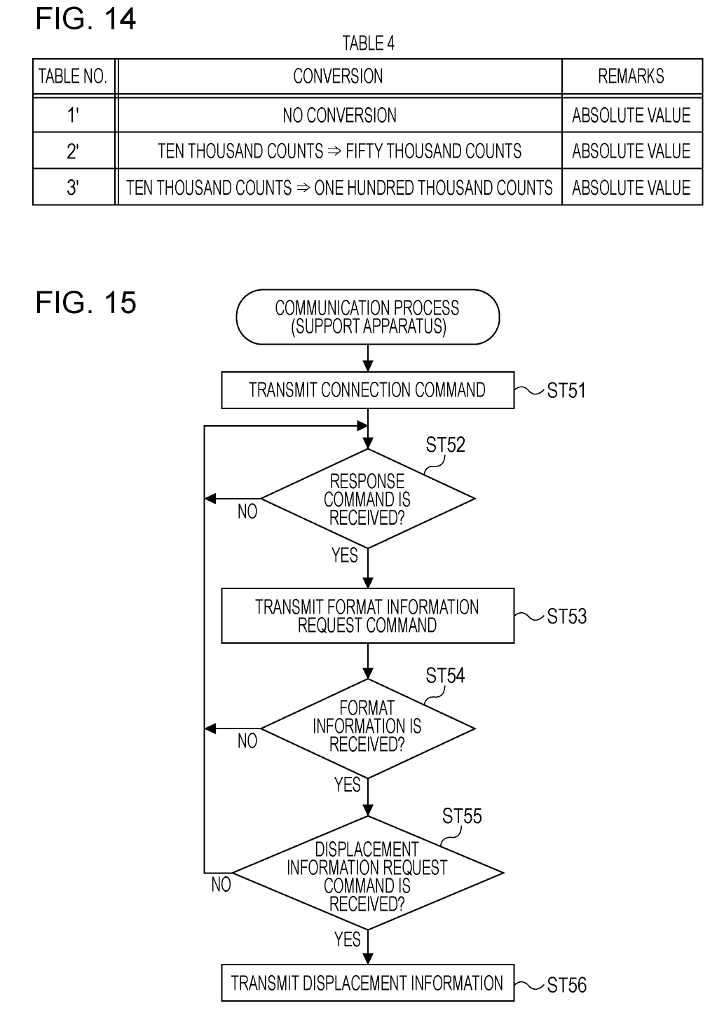

FIG. 14 is Table 4 showing three conversion tables No. 1′ to No. 3′ held in the memory 970. The conversion table No. 1′ is a conversion table in which no conversion is performed. The conversion table No. 2′ performs conversion in which ten thousand counts of the displacement information are converted into fifty thousand counts. The conversion table No. 3′ performs conversion in which ten thousand counts of the displacement information are converted into one hundred thousand counts. The memory 970 outputs a table signal (conversion table) S23.

The communication will now be described in detail with reference to FIG. 15. FIG. 15 is a flowchart showing an example of a communication process between the support apparatus 9 and the lens apparatus 8.

Referring to FIG. 15, in Step ST51, the support apparatus 9 transmits a connection command to the lens apparatus 8. In Step ST52, the support apparatus 9 waits for reception of a response command from the lens apparatus 8. If the support apparatus 9 receives the response command, then in Step ST53, the support apparatus 9 transmits a format information request command. In Step ST54, the support apparatus 9 waits for reception of format information. If the support apparatus 9 does not receive the format information for a predetermined time period, the process goes back to Step ST52. If the support apparatus 9 receives the format information, then in Step ST55, the support apparatus 9 waits for reception of a displacement information request command. If the support apparatus 9 does not receive the displacement information request command for a predetermined time period, the process goes back to Step ST52. If the support apparatus 9 receives the displacement information request command, then in Step ST56, the support apparatus 9 transmits displacement information.

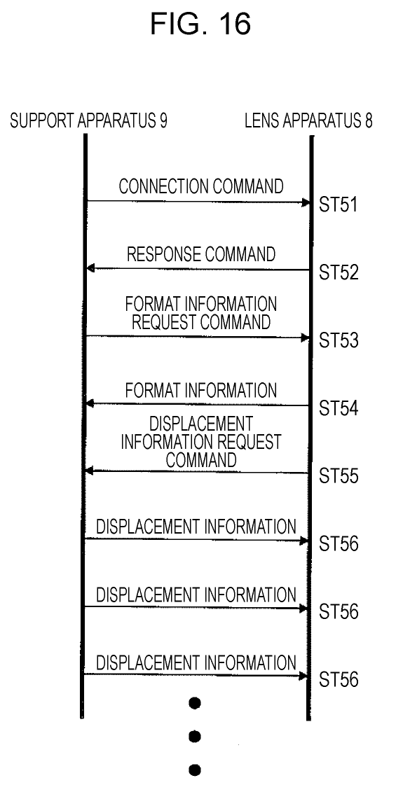

FIG. 16 is a sequence chart showing an example of the communication sequence between the support apparatus 9 and the lens apparatus 8.

The support apparatus 9 transmits the connection command to the lens apparatus 8 (Step ST51). When the support apparatus 9 receives the response command, which is a reply to the connection command, from the lens apparatus 8 (Step ST52), the support apparatus 9 transmits the format information request command to the lens apparatus 8 (Step ST53). The lens apparatus 8 transmits the format information (Step ST54). The lens apparatus 8 transmits the displacement information request command to the support apparatus 9 (Step ST55). The support apparatus 9 continues to transmit the displacement information S24 (S25) on a predetermined cycle (Step ST56).

With the above configuration, the support apparatus 9 acquires the information (the data format of the displacement information) about the process of converting the displacement information S24 (S25) into the control information S5 from the lens apparatus 8 by communication and switches the format of the displacement information output from the format selection switch 96 in accordance with the acquired information.

For example, since the lens apparatus 8 holds the conversion table No. 1 in the fourth exemplary embodiment, the support apparatus 9 receives the conversion table No. 1.

The format selection switch 96 selects a contact 1′. The detection result converter 971 acquires the conversion table No. 1′, which is a reverse conversion table of the conversion table No. 1, from the memory 970 and converts the displacement information S6 (S7) into the displacement information S24 (S25) to be output from the support apparatus 9.

As described above, according to the fourth exemplary embodiment, it is possible to agree the format of the image stabilization information output from the support apparatus 9 with the format of the image stabilization information (S24 and S25) processed in the lens apparatus 8 even when the lens apparatus 8 does not include the format selection switch, unlike the first to third exemplary embodiments. The support apparatus may acquire the format of the displacement information converted into the control information in the lens apparatus and may create the conversion table (the conversion table No. 1′ in the fourth exemplary embodiment) the format of which agrees with the acquired format.

It is possible to indicate whether the image stabilization is performed and whether the displacement information S24 (S25) output from the support apparatus is available for the image stabilization in the fourth exemplary embodiment. Accordingly, it is possible for a user to easily recognize the current state of the image stabilization by, for example, disabling the image stabilization in an intentional operation, such as the pan or tilt operation, and enabling the image stabilization only the static state.

It is possible to indicate to the user that the displacement information output from the support apparatus is available for the image stabilization also when the conversion table is automatically switched by communication. The display unit 85 may be provided in the camera apparatus 3 or the support apparatus 9, or may be provided in the system separately from the lens apparatus 8, the camera apparatus 3, and the support apparatus 9. The display unit may be a light-emitting-diode display unit. The content displayed in the display unit 85 is not limited to the ones described in the fourth exemplary embodiment.

The support apparatus 9 may be provided with a manual switch, like the format selection switch 11 provided in the lens apparatus 1 according to the first exemplary embodiment, to perform a conversion process in which the pan or tilt displacement information is converted into the displacement information to be output.

In the exemplary embodiments described above, the format selection switch (the format transmitting unit) may be provided in the support apparatus or the lens apparatus, or may be provided in the system separately from the support apparatus and the lens apparatus.

As described above, the image capturing system should include a format converting unit including the format selection switch 96, the memory 970, and the detection result converter 971 described in the fourth exemplary embodiment so as to communicate with the support apparatus and the support apparatus, separately from the support apparatus and the lens apparatus.

Although the image stabilization unit in the lens apparatus is used to perform the image stabilization in the exemplary embodiments described above, the image stabilization method is not limited to the above ones. An image pickup device in the camera apparatus may be mechanically shifted or video signals from the camera apparatus may be subjected to image processing.

### Fifth Exemplary Embodiment

The format selection switch switches the format of value of the displacement information, for example, between the angle value, the count value, and the pulse signal, between the digital value and the analog value, and between the absolute value and the relative value, in the first to fourth exemplary embodiments described above. In contrast, according to a fifth exemplary embodiment, the value of the displacement information is fixed and a time interval (hereinafter referred to as a cycle) at which the displacement information is transferred is switched.

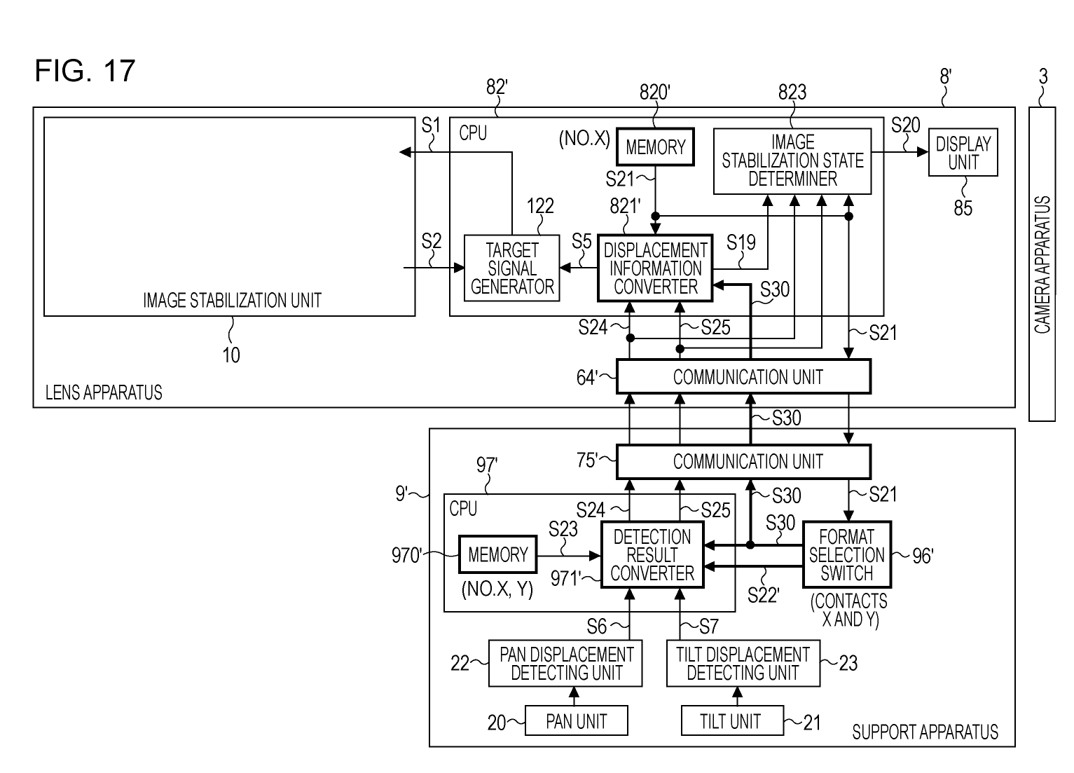

The fifth exemplary embodiment of the present invention will now be described with reference to FIGS. 17 to 20.

An image capturing system according to the fifth exemplary embodiment differs from the image capturing system according to the fourth exemplary embodiment in that the output cycle of the displacement information output from the detection result converter 971 in the support apparatus 9 and the input cycle of the displacement information received by the lens apparatus 8 are switched. The image capturing system according to the fifth exemplary embodiment differs from the image capturing system according to the fourth exemplary embodiment also in that the communication rate or the communication interval of the communication unit 64 in the lens apparatus 8 and the communication unit 75 in the support apparatus 9 are switched. It is assumed in the fifth exemplary embodiment that the displacement information output from the support apparatus is the angle value (absolute value) and the displacement information received by the lens apparatus is also the angle value (absolute value) and that the angle value output from the support apparatus coincides with the angle value received by the lens apparatus.

FIG. 17 is a functional block diagram showing an example of the configuration of the image capturing system according to the fifth exemplary embodiment of the present invention. The image capturing system includes a lens apparatus 8′, a support apparatus 9′, and the camera apparatus 3.

The lens apparatus 8′ mainly includes the image stabilization unit 10, a CPU 82′, a communication unit 64′, and the display unit 85.

The CPU 82′ mainly includes a memory 820′, a displacement information converter 821′, the target signal generator 122, and the image stabilization state determiner 823.

The memory 820′ includes only a conversion table No. X. The displacement information converter 821′ receives a communication selection signal S30, which is information about communication with the communication unit 64′ (75′), and acquires the conversion table No. X on the basis of the received communication selection signal S30. The displacement information converter 821′ switches a time element, such as the cycle, of the displacement information received by the lens apparatus 8′ on the basis of the conversion table No. X.

The communication unit 64′ receives the communication selection signal S30 to switch the communication rate or the communication interval.

The support apparatus 9′ mainly includes the pan unit 20, the tilt unit 21, the pan displacement detecting unit 22, the tilt displacement detecting unit 23, the communication unit 75′, a format selection switch 96′, and a CPU 97′.

The communication unit 75′ differs from the communication unit 75 in that the communication unit 75′ receives the communication selection signal S30 from the support apparatus 9′ to switch the communication rate or the communication interval.

The format selection switch 96′ functions as the format transmitting unit that discriminates the format of the displacement information convertible into the control information in the lens apparatus 8′ on the basis of the received conversion table S21 and that outputs the communication selection signal S30 in accordance with the discriminated format.

The CPU 97′ mainly includes a memory 970′ and a detection result converter 971′.

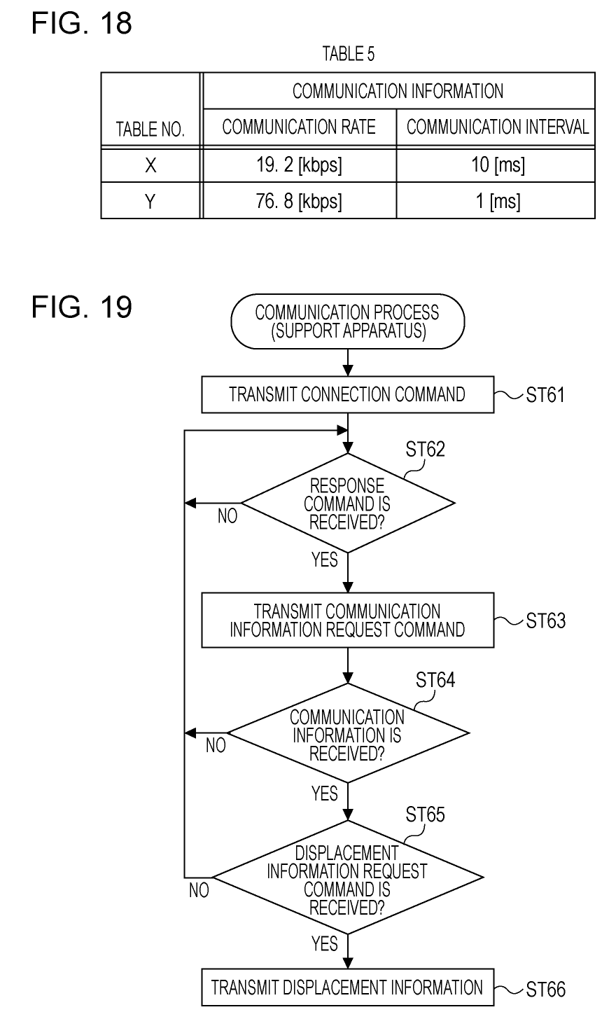

FIG. 18 is Table 5 showing two conversion tables No. X and No. Y held in the memory 970′. The memory 970′ holds information concerning the time elements of the communication with the communication unit 75′ (64′). The communication rate and the communication interval are indicated in the conversion tables No. X and No. Y. The conversion table No. X includes a communication rate of 19.2 [Kbps] and a communication interval of 10 [ms]. The conversion table No. Y includes a communication rate of 76.8 [Kbps] and a communication interval of 1 [ms]. The memory 970′ outputs a table signal (conversion table) S23.

The detection result converter 971′ differs from the detection result converter 971 in that the detection result converter 971′ receives the communication selection signal S30. The detection result converter 971′ switches a time element, for example, the output cycle of the displacement information S24 (S25) to be output therefrom.

The communication will now be described in detail with reference to FIG. 19. FIG. 19 is a flowchart showing an example of a communication process between the support apparatus 9′ and the lens apparatus 8′.

Referring to FIG. 19, in Step ST61, the support apparatus 9′ transmits a connection command to the lens apparatus 8′. In Step ST62, the support apparatus 9′ waits for reception of a response command from the lens apparatus 8′. If the support apparatus 9′ receives the response command, then in Step ST63, the support apparatus 9′ transmits a communication information request command. In Step ST64, the support apparatus 9′ waits for reception of communication information. If the support apparatus 9′ does not receive the communication information for a predetermined time period, the process goes back to Step ST62. If the support apparatus 9′ receives the communication information, then in Step ST65, the support apparatus 9′ waits for reception of a displacement information request command. If the support apparatus 9′ does not receive the displacement information request command for a predetermined time period, the process goes back to Step ST62. If the support apparatus 9′ receives the displacement information request command, then in Step ST66, the support apparatus 9′ transmits displacement information.

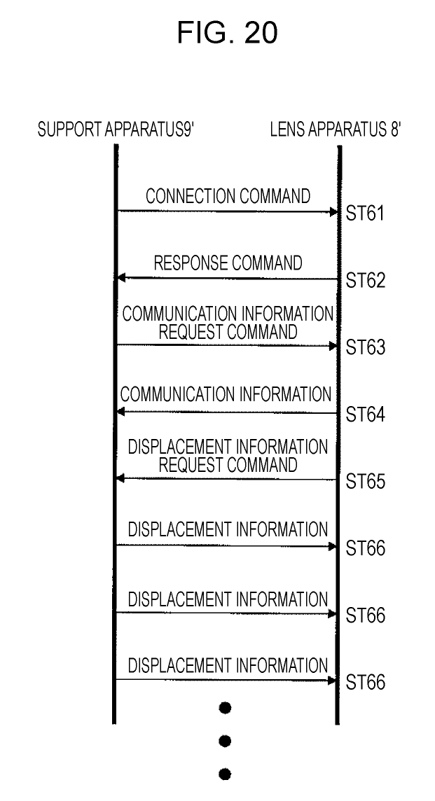

FIG. 20 is a sequence chart showing an example of the communication sequence between the support apparatus 9′ and the lens apparatus 8′.

The support apparatus 9′ transmits the connection command to the lens apparatus 8′ (Step ST61). If the support apparatus 9′ receives the response command, which is a reply to the connection command, from the lens apparatus 8′ (Step ST62), the support apparatus 9′ transmits the communication information request command to the lens apparatus 8′ (Step ST63). The lens apparatus 8′ receives the communication information request command and transmits the communication information (Step ST64). The communication information according to the fifth exemplary embodiment means the communication rate and the communication interval, as shown in Table 5 in FIG. 18. The lens apparatus 8′ transmits the displacement information request command to the support apparatus 9′ (Step ST65). The support apparatus 9′ continues to transmit the displacement information on a predetermined output cycle.

In the image capturing system having the above configuration according to the fifth exemplary embodiment, the support apparatus 9′ acquires the communication information held in the memory 820′ in the lens apparatus 8′ through the communication unit 75′ (the communication unit 64′). The format selection switch 96′ selects a contact on the basis of the acquired communication information and outputs a selection result signal S22′. Since the memory 820′ in the lens apparatus 8′ includes only the conversion table No. X in the fifth exemplary embodiment, the format selection switch 96′ selects the contact X.

The detection result converter 971′ receives the selection result signal S22′ and outputs the displacement information S24 (S25) on an output cycle based on the communication information (the conversion table No. X in the fifth exemplary embodiment) held in the memory 970′.

As described above, in the image capturing system according to the fifth exemplary embodiment, the support apparatus acquires the communication information through the communication units and switches the output cycle of the displacement information on the basis of the acquired communication information. The support apparatus also switches the communication rate or the communication interval.

Accordingly, even when the input cycle of the displacement information received by the lens apparatus differs from the output cycle of the displacement information output from the support apparatus, the lens apparatus can convert the displacement information supplied from the support apparatus into the control information used for the image stabilization by switching the input cycle of the lens apparatus or the output cycle of the support apparatus. The output cycle includes the communication rate and the communication interval. Conversely, the lens apparatus may acquire the output cycle of the support apparatus from the support apparatus and may switch the input cycle of the lens apparatus on the basis of the acquired output cycle (the same applies to the communication rate and the communication interval of the communication units).

Switching the input cycle of the lens apparatus may cause, for example, the import cycle of the arithmetic processor (hereinafter referred to as the CPU) receiving the displacement information to be switched or may cause the interval at which the displacement information is converted into the control information to be switched. Alternatively, switching the input cycle of the lens apparatus may cause the sampling time of the CPU to be switched.

The support apparatus can acquire information typified by arithmetic processing capabilities of the lens apparatus and can switch the output cycle on which the support apparatus outputs the displacement information on the basis of the acquired information to output the displacement information matching with the arithmetic processing capabilities of the lens apparatus. The arithmetic processing capabilities of the lens apparatus include the memory capacity, the arithmetic sampling rate, the amount of real-time processing load, and the image stabilization performance of the image stabilization unit.

For example, when the processing load on the CPU in the lens apparatus is high because various functions (zooming, focusing, irising, etc.) of the lens apparatus fully operate, it is desirable to reduce the processing load of the displacement information on the lens apparatus. In such a case, lengthening the output cycle on which the support apparatus outputs the displacement information allows the lens apparatus to lengthen the input cycle of the displacement information and the conversion cycle of the displacement information into the control information. Furthermore, lengthening the output cycle allows the communication rate of the communication unit in the lens apparatus to be reduced or allows the communication interval thereof to be lengthened. Consequently, it is possible to reduce the processing load on the CPU in the lens apparatus. In order to improve the image stabilization performance, the output cycle of the displacement information output from the support apparatus should be shortened. The same applies to the communication unit and so on.

Conversely, the input cycle of the displacement information received by the lens apparatus may be switched in accordance with the processing capability of the support apparatus. For example, the lens apparatus can acquire information typified by arithmetic processing capabilities of the support apparatus and can switch the time interval at which the displacement information is converted into the control information on the basis of the acquired information to receive the displacement information matching with the arithmetic processing capabilities of the support apparatus. The arithmetic processing capabilities of the support apparatus include the memory capacity, the arithmetic sampling rate, the amount of real-time processing load, and the resolution of the pan displacement detecting unit and the tilt displacement detecting unit.

For example, when the processing load on the CPU in the support apparatus is high because various functions (the image stabilizing function of the support apparatus itself and electromotive control of the pan unit and the tilt unit) of the support apparatus fully operate, it is desirable to reduce the processing load of the displacement information on the support apparatus. In such a case, lengthening the input cycle on which the lens apparatus receives the displacement information allows the support apparatus to lengthen the output cycle of the displacement information and the conversion cycle on which the displacement information is converted into the displacement information to be output. Furthermore, lengthening the output cycle allows the communication rate of the communication unit in the support apparatus to be reduced or allows the communication interval thereof to be lengthened. Consequently, it is possible to reduce the processing load on the CPU in the support apparatus. In order to improve the image stabilization performance, the input cycle of the displacement information received by the lens apparatus should be shortened. The same applies to the communication unit and so on.

Combinations of the formats of the displacement information concerning the time elements described above in the fifth exemplary embodiment and the formats of the values of the displacement information in the other exemplary embodiments may be switched from one to another. For example, to improve the image stabilization performance, the resolution of the values of the displacement information output from the support apparatus is maximized and the output cycle of the displacement information output from the support apparatus is reduced. The communication rate is increased and the communication interval is shortened in accordance with the resolution and the output cycle. In addition, the input cycle of the displacement information received by the lens apparatus is reduced and the time interval at which the displacement information is converted into the control information is also reduced. Furthermore, the resolution of the image stabilization process is improved and the cycle of the process is reduced in accordance with the reduced cycle and time interval. Conversely, to reduce the load of the image stabilization process, the reverse switching (settings) is performed. The switching described above may be performed at the start of the operation or at the turn-on. The switching may be performed by a photographer. A determining unit may be provided, which automatically sets the state of the switching to an optimal state in accordance with the operation status (arithmetic processing load) of the lens apparatus or the support apparatus. The photographer or the like may prioritize the image stabilization processes and may reflect the settings corresponding to the priorities on the determination by the determining unit.

As described above, according to the fifth exemplary embodiment, the time elements involved in the components from the displacement detecting units in the support apparatus detecting the displacement information to the displacement information converter converting the displacement information into the control information are switched to allow the lens apparatus to convert the displacement information output from the support apparatus into the control information. The time elements include the sampling time of the CPU, the communication rate, and the communication interval. The update cycle of the A/D converter importing the displacement information is also included in the time elements.

Although the communication format, such as the output cycle, of the displacement information to be output from the detection result converter 971′ in the support apparatus 9′ is switched with the format selection switch 96′ in the support apparatus 9′ in the fifth exemplary embodiment, a format selection switch may be provided in the lens apparatus 8′ and the communication format, such as the input cycle, of the lens apparatus 8′ may be switched in accordance with the communication format of the support apparatus 9′ with the format selection switch.

According to the exemplary embodiments of the present invention described above, the lens apparatus is provided with the format transmitting unit transmitting the signal used for discriminating the format of the displacement information output from the support apparatus to the converter. With this configuration, even when the format of the displacement information which the displacement information converter in the lens apparatus can convert into the control information differs from the format of the displacement information output from the support apparatus, it is possible for the lens apparatus to appropriately convert the displacement information into the control information, thus realizing the improved image stabilization.

Furthermore, the support apparatus is provided with the format transmitting unit transmitting the signal used for discriminating the format of the pan or tilt displacement information output from the support apparatus to the converter. With this configuration, even the lens apparatus without the format transmitting unit can appropriately convert the displacement information into the control information, thus realizing the improved image stabilization.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-199094 filed Jul. 31, 2007, which is hereby incorporated by reference herein in its entirety.

What is claimed is:

1. A lens apparatus configured to be electrically connected to a support apparatus including a detecting unit that detects displacement information corresponding to pan or tilt, the lens apparatus comprising:
a converter configured to convert the displacement information into control information;
an image stabilization unit configured to perform image stabilization by using the control information; and
a format transmitting unit configured to transmit a signal used for discriminating a format of the displacement information to the converter,
wherein the converter uses the signal transmitted from the format transmitting unit to convert the displacement information into the control information.

2. The lens apparatus according to claim 1,
wherein the format transmitting unit includes a mechanical switch used for selecting one format from a plurality of formats.

3. The lens apparatus according to claim 1,
wherein the formats include a time interval of the conversion process performed by the converter.

4. The lens apparatus according to claim 1,
wherein the formats include a time interval at which the support apparatus outputs the displacement information.

5. The lens apparatus according to claim 1,
wherein the formats includes an interval of communication between the lens apparatus and the support apparatus.

6. The lens apparatus according to claim 1,
wherein the format transmitting unit acquires information concerning the format of the displacement information by communication with the support apparatus.

7. A support apparatus configured to be electrically connected to a lens apparatus including an image stabilization unit that performs image stabilization by using control information, the support apparatus comprising:
a detecting unit configured to detect displacement information corresponding to pan or tilt;
a converter configured to convert a format of the displacement information into a format of displacement information to be transmitted to the lens apparatus; and
a format transmitting unit configured to transmit a signal used for discriminating the format of the displacement information that can be converted into the control information in the lens apparatus to the converter,
wherein the converter uses the signal transmitted from the format transmitting unit to convert the format of the displacement information.

8. The support apparatus according to claim 7,
wherein the format transmitting unit includes a mechanical switch used for selecting one format from a plurality of formats.

9. The support apparatus according to claim 7,
wherein the formats include a time interval of the conversion process performed by the converter.

10. The support apparatus according to claim 7,
wherein the formats include a time interval at which the support apparatus outputs the displacement information.

11. The support apparatus according to claim 7,
wherein the formats includes an interval of communication between the lens apparatus and the support apparatus.

12. The support apparatus according to claim 7,
wherein the format transmitting unit acquires information concerning the format of the displacement information by communication with the lens apparatus.

13. An image capturing system comprising:
a support apparatus including a detecting unit that detects displacement information corresponding to pan or tilt;
a lens apparatus including an image stabilization unit that performs image stabilization by using control information converted from the displacement information; and
a format conversion apparatus electrically connected to the support apparatus and the lens apparatus, the format conversion apparatus including a converter that converts a format of the displacement information output from the support apparatus into a format of displacement information that can be converted into the control information in the lens apparatus.
